(19) United States
(12) Patent Application Publication
(10) Pub. No.: US 2026/0073135 A1
(43) Pub. Date: Mar. 12, 2026

(54) TRANSACTION EVALUATION AGAINST RULES USING LARGE LANGUAGE MODELS

(71) Applicant: INTERNATIONAL BUSINESS MACHINES CORPORATION, Armonk, NY (US)

(72) Inventors: Kyle Gene Brown, Apex, NC (US); Steven Edward Atkin, Austin, TX (US)

(21) Appl. No.: 18/830,001

(22) Filed: Sep. 10, 2024

(51) Int. Cl. G06F 40/205; G06F 8/30

(52) U.S. Cl. CPC G06F 40/205; G06F 8/30

(57) ABSTRACT

A computer-implemented method for evaluating transactions against rules includes parsing sections of a document with conditional language and generating rules from the conditional language using a large language model. The rules are associated with corresponding sections of the document such that when a rule fires the rule is associated with the corresponding sections of the document. The rules are executed against transactions to discover exceptions. A narrative is generated to explain the exceptions to a user. The narrative includes the rules with the corresponding sections and an explanation.

### BACKGROUND

The present invention generally relates to generative artificial intelligence (AI) systems and, more particularly, to systems and methods for evaluating transactions against rules generated using large language models.

Large language models (LLMs) are the underlying category of artificial intelligence (AI) models. LLMs are a type of artificial neural network trained on a large corpus of text data. These models use a technique called likelihood-based text completion to predict a most probable next word or sequence of words given a previous context. The LLM determines a probability of each possible word and selects a most likely one based on the training data. LLMs can employ a type of neural network called a transformer, which is designed to handle long-range dependencies in text data. The transformer can have multiple layers that process input text data. Each layer refines and adds to the LLM's understanding of the text.

During training, the LLM is presented with a large dataset of text, such as the text of contracts or transactions, and a model is trained to predict the next word or sequence of words in the text. The model learns to identify patterns and relationships in the text data, such as the frequency of certain words, phrases, or syntactical structures.

One problem is that many current techniques most often rely on parsing a contract on the fly and ask the LLM what parts of the contract apply to each transaction. This can result in many added calls to the LLM. This reduces computer efficiency and results in delays by tying up resources.

Therefore, a need exists for systems and methods that train models that result in fewer LLM calls.

### SUMMARY

In accordance with an embodiment of the present invention, a computer-implemented method for evaluating transactions against rules includes parsing sections of a document with conditional language and generating rules from the conditional language using a large language model. The rules are associated with corresponding sections of the document such that when a rule fires the rule is associated with the corresponding sections of the document. The rules are executed against transactions to discover exceptions. A narrative is generated to explain the exceptions to a user. The narrative includes the rules with the corresponding sections and an explanation.

In accordance with another embodiment of the present invention, a transaction evaluation system includes a hardware processor and a memory that stores a computer program which, when executed by the hardware processor, causes the hardware processor to parse sections of a document with conditional language; generate rules from the conditional language using a large language model; associate the rules with corresponding sections of the document such that when a rule fires the rule is associated with the corresponding sections of the document; execute the rules against transactions to discover exceptions; and generate a narrative to explain the exceptions to a user, the narrative including the rules with the corresponding sections and an explanation.

In accordance with another embodiment of the present invention, a computer program product for deploying a system, the computer program product comprising a computer readable storage medium having program instructions embodied therewith, the program instructions executable by a hardware processor to cause the hardware processor to parse sections of a document with conditional language; generate rules from the conditional language using a large language model; associate the rules with corresponding sections of the document such that when a rule fires the rule is associated with the corresponding sections of the document; execute the rules against transactions to discover exceptions; and generate a narrative to explain the exceptions to a user, the narrative including the rules with the corresponding sections and an explanation.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block diagram of a system for evaluating transactions against rules, in accordance with an embodiment of the present invention;

FIG. 2 is a block diagram showing a system/method for evaluating transactions against rules using prompts to a large language model, in accordance with an embodiment of the present invention;

FIG. 3 is a block diagram showing a system/method for employing a Langchain orchestrator and agents to evaluate transactions against rules using prompts to a large language model, in accordance with an embodiment of the present invention;

FIG. 4 is a diagram showing an example of a transaction that has triggered an exception to a rule and a narrative response, in accordance with an embodiment of the present invention;

FIG. 5 is a block/flow diagram showing a system/method for evaluating transactions against rules, in accordance with an embodiment of the present invention; and

FIG. 6 is a flow diagram showing methods for evaluating transactions against rules using a large language model, in accordance with an embodiment of the present invention;

### DETAILED DESCRIPTION

In accordance with embodiments of the present invention, systems and methods are described for evaluating transactions against rules. In a situation where a contract or other document defines a course of action or behavior that needs to be evaluated, a step of generating rules from the contract or document is performed. This identifies rules in the document from which actions can be evaluated. Then, by asking a large language model (LLM) to explain why a particular rule is tied to what it previously discovered already in the document, results can be output with fewer LLM calls. An optimization that results is that instead of calling the LLM many times (once for every evaluation of a contract or document against each transaction or action), the LLM is only called for known violations. Many transactions will not result in a rule violation and thus will not require an LLM call.

In an embodiment, a system for efficiently evaluating transactions against rules generated by a LLM with explainability includes a document parser that parses a document to identify algorithmic rules such as, e.g., if-then style statements in the document. A rule generator generates rules from the algorithmic rules (e.g., if-then style statements) or statements and stores the rules in a rules engine. The rules engine receives a transactions event stream and compares the transaction events to the rules to determine violations or exceptions. A narrative generator receives sections of the parsed document and exceptions for rule violations to generate a narrative. The narrative can include a description of the nature of the violation, the section of the document where such a violation is described and additional details regarding the violation. The event can be further processed to provide remedial action, such as, e.g., fixing the problem, providing an alert or notification of the exception or violation, etc.

In an embodiment, a method for efficiently evaluating transactions against rules generated by an LLM with explainability includes parsing, by the LLM, a document and extracting one or more parts of the document that are capable of being expressed as algorithmic rules such as, e.g., if-then style statements. One or more sections of the document are identified through document references or uniform source locator (URL) links. Rules are generated for a specific rule-based language or library set with a special-purpose code generator LLM model tuned to the language or library. Sections of the document where the rules are ambiguous are identified. The ambiguity is resolved by specifying necessary details that will be used in the creation of the rule and in the explanation that is logged. The resolution of ambiguities can be provided by a user (e.g., a human review). Code is automatically updated to ensure a prompt includes an instruction to add a document reference, from which the rule was taken, to the code so that the document reference is logged when the rule fires. The document reference can be logged in the log at execution time. The tuned LLM can parse the logs including the relevant document references. The tuned LLM uses the relevant document references in an explanation of the decision as a narrative.

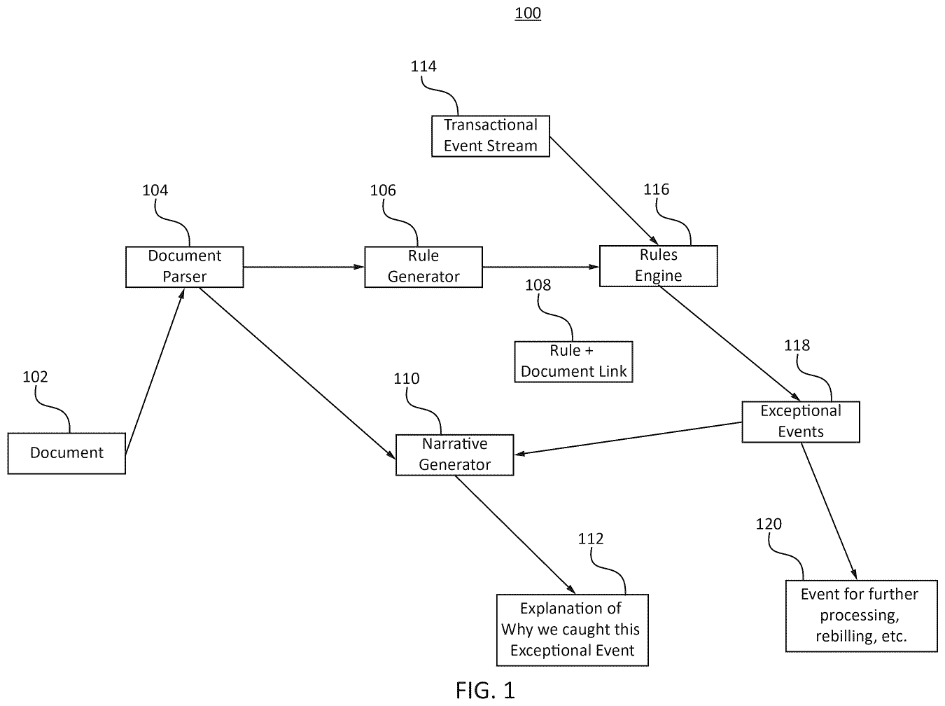

Referring now to the drawings in which like-numerals represent the same or similar elements and initially to FIG. 1, a block/flow diagram shows a system 100, which can evaluate a document for rules and determine whether rules have been violated or adhered to. The system 100 further includes an explanation of the rules that had been violated to provide a user with greater details about the violation or exception. In an embodiment, a document 102 can include any document, written, acoustically recorded or recorded by another method. The document 102 can include a contract, a rule book, an instruction manual, a warranty or any other type of document where conditional events and consequences may be described. The document 102 can be ingested by a document parser 104, e.g., a contract parser, which can parse the document 102 into conditional statements that will be formulated into rules. In one example, if-then statements can be identified within the text of the document. The document parser 104 reviews the document 102 and considers sections based on contextual information. The sections with potential rules are identified. In one embodiment, artificial intelligence can be employed to assist in identifying sections with potential rules within the document 102.

The sections with potential rules are fed to a rule generator 106. The rule generator 106 can fashion rules from the identified sections. Rules and/or links to rules 108 are output from the rule generator 106. The rules and/or links to rules 108 are then executed by a rules engine 116 when triggered in accordance with a transactional event stream 114. The rule generator 106 monitors the transactional event stream 114 to determine whether exceptions (or violations) are encountered. The transactional event stream 114 can be any event stream that monitors activity of entities or individuals bound by the document 102. In some examples, the document 102 can include a lease and the transactional event stream 114 can include a rent payment log that include other activities. If one or more activities are non-compliant, they are flagged by the rule generator 106. In another example, a computer network can include number of nodes that may include bandwidth requirements. The transactional event stream 114 can include bandwidth monitoring for the nodes. In another example, a distributed computer system can have anomaly detection system with specification compliance as the transactional event stream 114. Other systems and applications are also contemplated.

The document parser 104 finds the sections in the document 102 that are equivalent to rules that can be generated by the rule generator 106. Those sections can be represented by a link to the original document 102 (a deep link) or a page and paragraph reference. The rule generator 106 can embed a link or reference back to the original text in the code that it outputs so that when the rule fires inside of the rules engine 116, the link or reference is added into the log of exceptional events along with the identifiers of the rule that fired. A narrative generator 110 uses that information to dereference that link or reference created by the document parser 104 (which can include a URL, or an identifier like page and paragraph number from the original text). The narrative generator 110 uses the original text from the document 102 in the form in which it was identified by the document parser 104.

Any exceptional events caught from the transactional event stream 114 stream by the rules engine 116 can be stored in exceptional events storage 118. Once exceptions (violations) are generated, the exceptions can trigger, from rules fired, the narrative generator 110 which uses an exception log of the exceptional events storage 118 to provide an explanation as to why the exception was flagged and where in the document 102 the rule came from to explain the exceptional events.

The exceptional events can also trigger a device or system 120 for further processing. In an embodiment, the exception may trigger a fine or other penalty. An email may be automatically generated with an invoice to be sent to an entity that caused the exception. In an anomaly detection situation, an alert can be forwarded to a repair person or a ticket can be created. In still other embodiments, a piece or hardware may be automatically taken off-line or substituted with another piece of hardware.

It should be understood that elements or the system 100 or the entire system can employ artificial intelligence capabilities to train the system 100 and handle exceptions at an inference stage. In an embodiment, the artificial intelligence capabilities can be implemented by fine-tuning a model from a LLM to parse the document, generate rules, execute the rules and provide a narrative explanation as described.

By first generating rules, by the rule generator 106, from the document 102, a reduction in LLM accesses or calls is achieved. In this way, the LLM only needs to be asked to explain why a particular rule fired (tied to what it already found in the document 102) resulting in fewer LLM calls. One optimization is that instead of calling the LLM many times (once for every evaluation of a document against each transaction), the LLM only needs to be called for parts which are known to be violations. Many transactions will not result in a rule violation and thus will not require an LLM call.

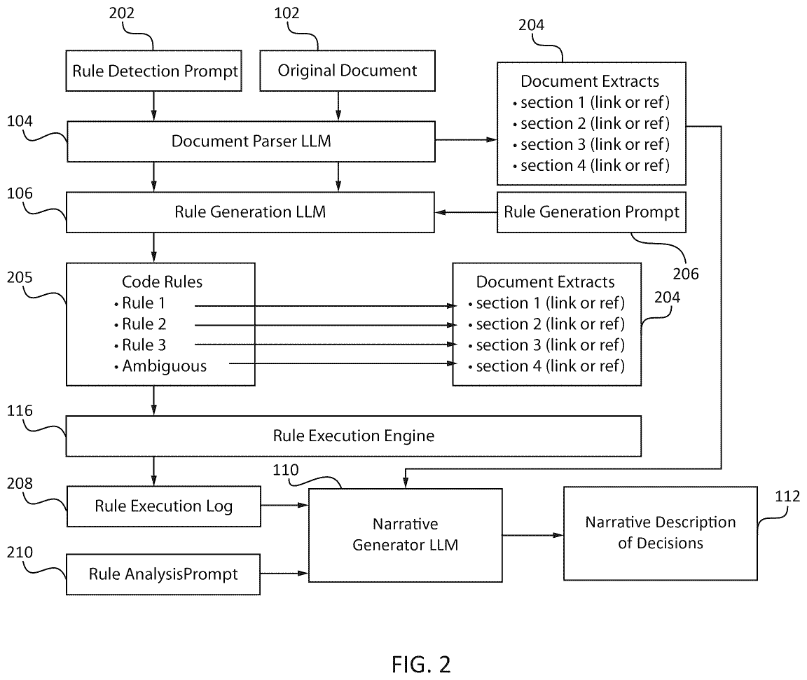

Referring to FIG. 2, a system/method for evaluation of documents is shown in accordance with the embodiments of the present invention. The document parser 104 can be triggered by a rule detection prompt 202 employed to have the LLM parse the document 102 and extract out the parts of the document 102 as document extracts 204 that could be expressed as algorithmic rules such as, e.g., simple if-then style rules.

A rule generation prompt 206 can be employed to have the LLM create the rule generator 106. The rule generator 106 identifies the section of documents (document extracts 204) either through document references, e.g. section and page or through URL links. Rules 205 are generated by the rule generator 106 for a specific rule-based language or library set with a special-purpose code generator LLM tuned to that language or library. A specific subset of rules-based tools and libraries are selected for which sufficient examples exist to reliably generate rules. The rule detection prompt 202 can be used to identify rules-based tools and libraries from the LLM. A coding-specific LLM model (such as, e.g., code-llama) can be employed to generate the rules from the specifically tuned prompts. The rules can be generated for a specific rule-based language or library set with a special-purpose code generator LLM tuned to that language or library.

Fine-tuning can be performed on the model or additional synthetic data can be generated to refine the model. The LLM can parse the document 102 and extract out the parts of the document that could be expressed as algorithmic rules such as, e.g., if-then style statements. The sections of documents (either through document references, e.g. section and page) or through URL links are identified.

The sections of documents (document extracts 204) for which the rules may be ambiguous can be resolved by artificial intelligence or by a human. The ambiguity can be resolved by specifying the details necessary that will be used in the creation of the rule and in the explanation that is logged. During the generation of the code rules, the rule generation prompt 206 can include an instruction to add the document reference from which the rule was taken so that the document reference is logged when the rule fires.

At execution time, the rules engine 116 or rule execution engine looks for exceptions in transactions. A rule analysis prompt 210 is triggered based on exceptions generated during the rule execution. A rule code execution log 208 logs the document references for input to the narrative generator 110. The LLM parses the logs including the relevant document references and uses that in the explanation of the decision as a narrative description of decisions in block 112.

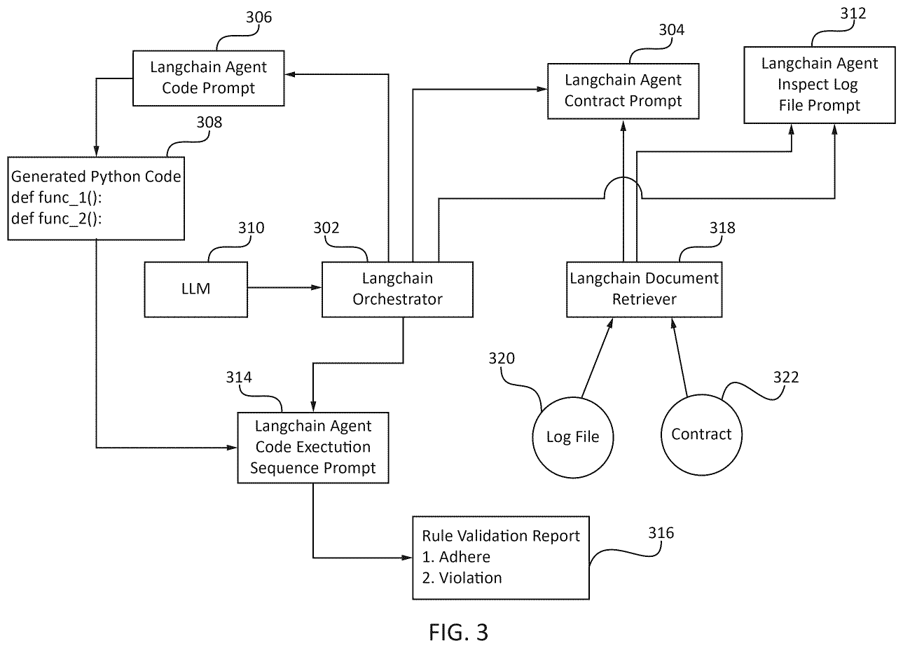

Referring to FIG. 3, a method for creating a system/method for evaluating documents using a Langchain agent is shown in accordance with embodiments of the present invention. A use case for Langchain includes creating agents. Agents are systems that use LLMs, e.g., watsonx. ai, as reasoning engines to determine which actions to take and the inputs needed for them. After executing actions, the results can be fed back into the LLM to determine whether more actions are needed, or whether the task is complete. An agent in Langchain determines and performs a series of actions based on a language model, choosing what to do and when to do it. The Langchain agent receives feedback to assess whether additional actions are needed or if the task is complete. Langchain supports many different language models that can be employed interchangeably. While Langchain is described as an example, other agents and agent orchestrators can also be employed.

In accordance with an embodiment, a contract 322 (or other document) that needs to be evaluated is fed to a Langchain document retriever 318 of an LLM along with a log file 320 (of exceptions). A Langchain orchestrator 302 can be employed to organize interactions with the LLM. Langchain orchestrator 302 can have the LLM parse the contract 322 and extract out the parts of the document that could be expressed as algorithmic rules such as if-then style statements using a Langchain agent 304 and a contract prompt.

The Langchain agent 304 can execute the following example contract prompt to the LLM. A contract prompt can include the following: “Kindly examine the presented contract and extract essential components that can be transformed into a collection of executable directives. Search for blank spaces that call for particular data, alternatives to select from, circumstances leading to specific duties, and any tasks assigned to the involved parties. Translate these components into unambiguous, enforceable rules that could be integrated into a system to guarantee the contract's conditions are met and adhered to.”

The Langchain orchestrator 302 can have an LLM 310 identify the section of documents (either through document references, e.g. section and page) or through URL links using a Langchain agent 306. The Langchain agent 306, using a code prompt, generates the rules for a specific rule-based language or library set with a special-purpose code generator LLM tuned to that language or library. An illustrative code prompt for the Langchain agent 306 can include the following: “Kindly transform the recognized rules from the contract into Python code. Develop individual functions that can validate inputs, determine dates, implement conditions, and verify compliance with the contractual terms. The code should manage data validation, logical procedures, condition assessments, and generate the status of conformity or any mistakes for rectification. Each rule must be translated into an independent function that accepts pertinent contractual data as parameters and returns an outcome that signifies whether the rule has been met.”

Generated Python code 308 is output. The Langchain agent 306 identifies the sections of documents for which the rules may be ambiguous, and allow a human or machine to resolve the ambiguity by specifying the details necessary that will be used in the creation of the rule and in the explanation that is logged.

The Langchain orchestrator 302 can have a Langchain agent 314 generate rule code logs and the document reference in the log. This can be implemented by the LLM 310 using an execution sequence prompt. An illustrative execution sequence prompt can include the following: “Design a procedure for the execution of the Python functions representing the contract rules. The sequence should mirror the logical structure of the contract, guaranteeing that prerequisites are fulfilled before dependent rules are examined. Initiate the process with input validation functions, proceed with calculations and conditional logic. Make sure the output of one function is effectively utilized as input to any subsequent functions if necessary. Lastly, construct a coordination function that invokes all the individual rule functions in the suitable order and amalgamates their results into a report.”

The LLM parses the logs including the relevant document references and uses that in the explanation of the decision as a narrative. A rule evaluation report 316 can include a log of adherence or violations or rules.

The Langchain orchestrator 302 can have a Langchain agent 312 make sure that a prompt includes the instruction to add the document reference associated with the rule code so that the association is logged when the rule fires. This can be implemented using an inspect log file prompt. An inspect log file prompt can include: “Kindly scrutinize the log file given, which records all the essential events concerning the contract. Decipher the entries to isolate essential data points such as dates, monetary values, names, delivery details, and conformity indicators. Subsequently, methodically employ the pre-established Python functions to this data to ensure compliance with the contract's provisions. For each rule, report whether the contract's conditions have been satisfied, and underscore any inconsistencies or infringements detected within the log's records.”

It should be understood that while Python is referenced as a programming language, any suitable programming language can be employed.

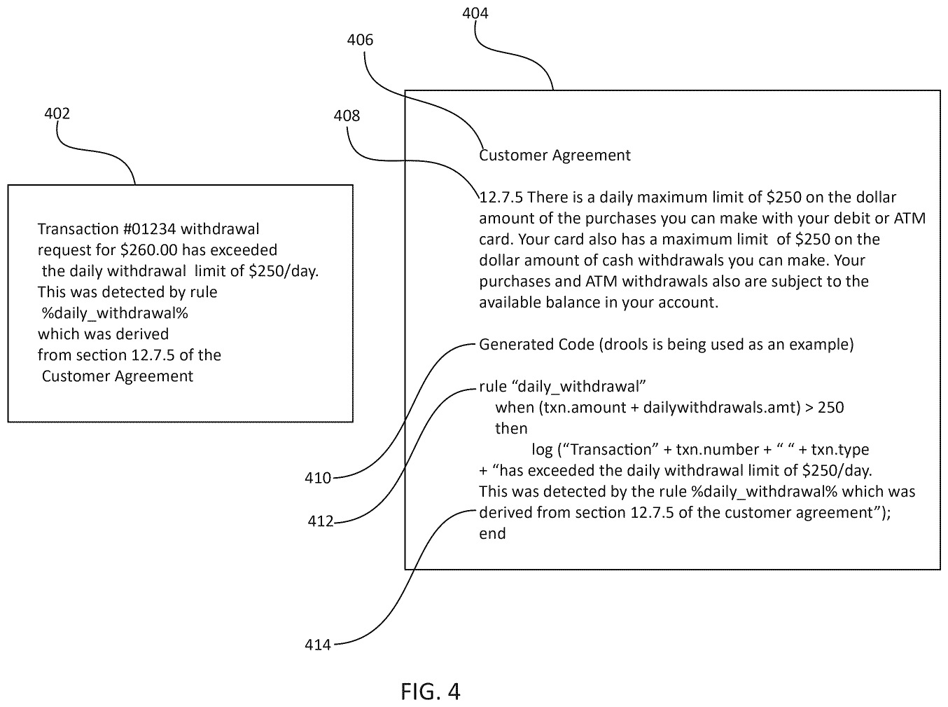

Referring to FIG. 4, an illustrative example includes a transaction explanation 402 (see also block 112, FIG. 1) and corresponding information within a customer agreement 404 to demonstrate embodiments of the present invention. The transaction explanation 402 has been triggered by the rules engine 116 and the explanation by narrative generator 110 for a withdrawal request for $260, which exceeds a daily permitted withdrawal amount of $250 per day. In accordance with a document labeled customer agreement 406, a section 12.7.5 limits ATM use to $250 per day. Generated code 410 includes a rule 412 generated by drools (a rule engine) that includes a formula having a conditional relationship to test the transaction. Since transaction #01234 exceeded the rule, a violation was triggered and the transaction explanation 402 was output that included explanation 414 as well as the section 12.7.5 and the identity of the rule 412 (e.g., %daily_withdrawal%).

Embodiments of the present invention employ artificial machine learning systems which can be used to predict outcomes based on input data, e.g., rules parsed from documents, generation of narrative language, etc. In an example, given a set of input data, a machine learning system can predict an outcome. The machine learning system will likely have been trained on much training data in order to generate its model. It will then predict the outcome based on the model.

In some embodiments, the artificial machine learning system includes an artificial neural network (ANN). One element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN is configured for a specific application, such as pattern recognition or data classification, through such a learning process.

The present embodiments may take any appropriate form, including any number of layers and any pattern or patterns of connections therebetween. ANNs demonstrate an ability to derive meaning from complicated or imprecise data and can be used to extract patterns and detect trends that are too complex to be detected by humans or other computer-based systems. The structure of a neural network is known generally to have input neurons that provide information to one or more “hidden” neurons. Connections between the input neurons and hidden neurons are weighted, and these weighted inputs are then processed by the hidden neurons according to some function in the hidden neurons. There can be any number of layers of hidden neurons, and as well as neurons that perform different functions. There exist different neural network structures as well, such as a convolutional neural network, a maxout network, transformers, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. A set of output neurons accepts and processes weighted input from the last set of hidden neurons.

This represents a “feed-forward” computation, where information propagates from input neurons to the output neurons. Upon completion of a feed-forward computation, the output is compared to a desired output available from training data. The error relative to the training data is then processed in “backpropagation” computation, where the hidden neurons and input neurons receive information regarding the error propagating backward from the output neurons. Once the backward error propagation has been completed, weight updates are performed, with the weighted connections being updated to account for the received error. It should be noted that the three modes of operation, feed forward, back propagation, and weight update, do not overlap with one another. This represents just one variety of ANN computation, and that any appropriate form of computation may be used instead. In the present case the output neurons provide emission information for a given plot of land provided from the input of satellite or other image data.

To train an ANN, training data can be divided into a training set and a testing set. The training data includes pairs of an input and a known output. During training, the inputs of the training set are fed into the ANN using feed-forward propagation. After each input, the output of the ANN is compared to the respective known output or target. Discrepancies between the output of the ANN and the known output that is associated with that particular input are used to generate an error value, which may be backpropagated through the ANN, after which the weight values of the ANN may be updated. This process continues until the pairs in the training set are exhausted.

After the training has been completed, the ANN may be tested against the testing set or target, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, each weight may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs. Alternatively, the weights may be implemented as resistive processing units (RPUs), generating a predictable current output when an input voltage is applied in accordance with a settable resistance.

A neural network becomes trained by exposure to empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

A deep neural network, such as a multilayer perceptron, can have an input layer of source nodes, one or more computation layer(s) having one or more computation nodes, and an output layer, where there is a single output node for each possible category into which the input example could be classified. An input layer can have a number of source nodes equal to the number of data values in the input data. The computation nodes in the computation layer(s) can also be referred to as hidden layers, because they are between the source nodes and output node(s) and are not directly observed. Each node in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . w_{n-1,} wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

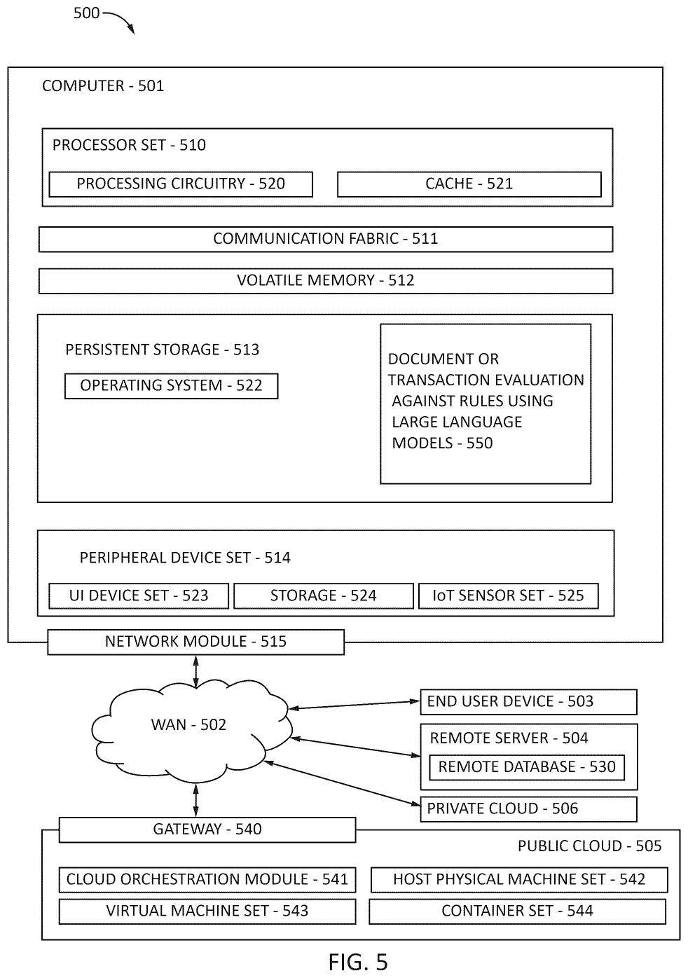

Referring now to FIG. 5, a block diagram of a computing environment is shown. Computing environment 500 contains an example of an environment for the execution of at least some of the computer code involved in performing the inventive methods, such as document or transaction evaluation against rules using large language models in block 550. In addition to block 550, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 550, as identified above), peripheral device set 514 (including user interface (UI) device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible.

Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in block 550 in persistent storage 513.

COMMUNICATION FABRIC 511 is the signal conduction path that allows the various components of computer 501 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, volatile memory 512 is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface-type operating systems that employ a kernel. The code included in block 550 typically includes at least some of the computer code involved in performing the inventive methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices.

Computer readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN 502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502. Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

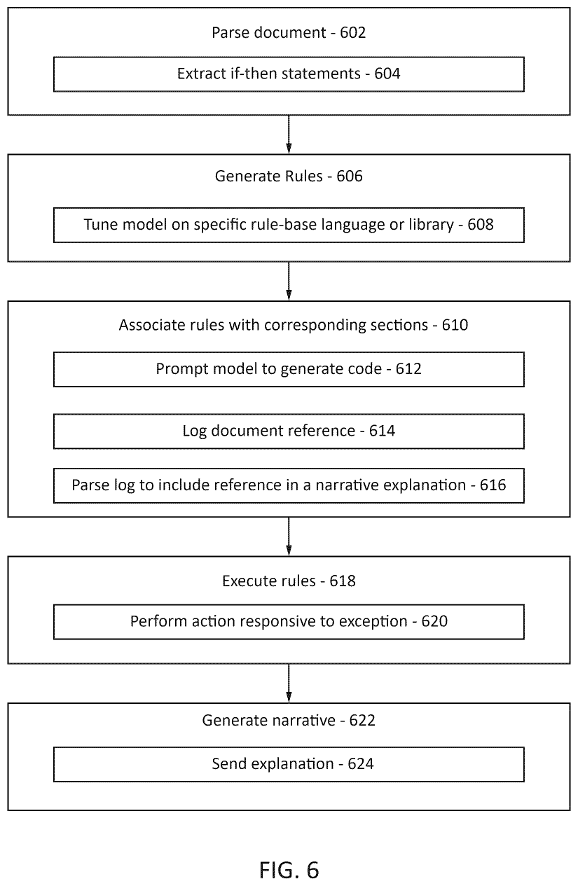

Referring to FIG. 6, computer-implemented methods for evaluating transactions against rules are shown in accordance with embodiments of the present invention. In block 602, sections of a document with conditional language are parsed to locate rules within the document. The document can include any document on any recorded medium. The document can be parsed using a document parser. In an embodiment, the document parser can employ an LLM to parse the document. In block 604, algorithmic rules (e.g., if-then style rules) can be extracted. Other conditional language can also be parsed and extracted to generate rules.

In block 606, rules are generated from the conditional language using a large language model. In block 608, the large language model can be tuned to a specific rule-based language or library set with a special-purpose code generator large language model. The rules can be generated before runtime to reduce calls to the large language model.

In block 610, the rules are associated with corresponding sections of the document such that when a rule fires the rule is associated with the corresponding sections of the document. The rule association can be performed using the LLM.

In block 612, the large language model can be prompted where the prompt includes an instruction to add a document reference, from which the rule was taken, to generate code so that document reference is logged when the rule fires. In block 614, the document reference can be logged in a log at execution time. In block 616, the logs can be parsed, by the large language model, to be included as relevant document references in an explanation narrative. The document reference can include a URL link, a page and section number, etc.

In block 616, for the corresponding sections of the document where the rules are ambiguous, the ambiguity can be resolved by specifying necessary details needed in creation of the rule and in the explanation. The resolution can be machine-based or human-based.

In block 618, the rules are executed against transactions to discover exceptions or violations. In block 620, responsive to an exception, an automatic notification action or other action (e.g.,. sending an invoice, substituting equipment, shutting down a device, etc.) can be performed. The notification action can be sent to an entity that caused the exception. The notification action can be automatic. The exceptions can be logged in an exception log.

In block 622, a narrative is generated to explain the exceptions to a user. The narrative can include the rule(s) with the corresponding section(s) and an explanation. The narrative can be generated by the LLM. The narrative can be generated by the LLM. The narrative can be automatically sent to an entity to which it pertains in block 624. Other actions can also be performed in block 622. These can include actions such as substituting equipment, generating an invoice, turning on a device or other actions consistent with the execution of rules in accordance with the document conditions.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments for systems and methods (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method for evaluating transactions against rules, comprising:
parsing sections of a document with conditional language;
generating rules from the conditional language using a large language model;
associating the rules with corresponding sections of the document such that when a rule fires the rule is associated with the corresponding sections of the document;
executing the rules against transactions to discover exceptions; and
generating a narrative to explain the exceptions to a user, the narrative including the rules with the corresponding sections and an explanation.

2. The method of claim 1, wherein parsing sections of the document with conditional language includes extracting statements expressed as if-then style rules.

3. The method of claim 1, wherein associating the rules with corresponding sections of the document includes prompting the large language model with a prompt that includes an instruction to add a document reference, from which the rule was taken, to generated code so that document reference is logged when the rule fires.

4. The method of claim 3, further comprising:
logging the document reference in a log at execution time; and
parsing, by the large language model, the log including the document reference in the explanation.

5. The method of claim 3, wherein the document reference includes a uniform resource locator (URL) link.

6. The method of claim 1, wherein associating the rules with corresponding sections includes:
identifying the corresponding sections for which the rules are ambiguous; and
resolving an ambiguity by specifying necessary details needed in creation of the rule and in the explanation.

7. The method of claim 1, wherein generating rules from the conditional language includes tuning the large language model on a specific rule-based language or library set with a special-purpose code generator large language model.

8. The method of claim 1, further comprising responsive to an exception, performing an automatic notification action to an entity that caused the exception.

9. The method of claim 1, wherein the rules are generated before runtime to reduce calls to the large language model.

10. A transaction evaluation system, comprising:
a hardware processor; and
a memory that stores a computer program which, when executed by the hardware processor, causes the hardware processor to:
parse sections of a document with conditional language;
generate rules from the conditional language using a large language model;
associate the rules with corresponding sections of the document such that when a rule fires the rule is associated with the corresponding sections of the document;
execute the rules against transactions to discover exceptions; and
generate a narrative to explain the exceptions to a user, the narrative including the rules with the corresponding sections and an explanation.

11. The system of claim 10, wherein the computer program causes the hardware processor to extract statements expressed as if-then style rules.

12. The system of claim 10 wherein the computer program causes the hardware processor to prompt the large language model with a prompt that includes an instruction to add a document reference, from which the rule was taken, to generated code so that document reference is logged when the rule fires.

13. The system of claim 12, wherein the computer program causes the hardware processor to log the document reference in a log at execution time; and parse, by the large language model, the log including the document reference in the explanation.

14. The system of claim 12, wherein the document reference includes a uniform resource locator (URL) link.

15. The system of claim 10, wherein the computer program causes the hardware processor to identify the corresponding sections for which the rules are ambiguous; and resolve an ambiguity by specifying necessary details needed in creation of the rule and in the explanation.

16. The system of claim 10, wherein the computer program causes the hardware processor to tune the large language model on a specific rule-based language or library set with a special-purpose code generator large language model.

17. The system of claim 10, wherein the computer program causes the hardware processor to, responsive to an exception, perform an automatic notification action to an entity that caused the exception.

18. The system of claim 10, wherein the rules are generated before runtime to reduce calls to the large language model.

19. A computer program product for deploying a transaction evaluation system, the computer program product comprising a computer readable storage medium having program instructions embodied therewith, the program instructions executable by a hardware processor to cause the hardware processor to:
parse sections of a document with conditional language;
generate rules from the conditional language using a large language model;
associate the rules with corresponding sections of the document such that when a rule fires the rule is associated with the corresponding sections of the document;
execute the rules against transactions to discover exceptions; and
generate a narrative to explain the exceptions to a user, the narrative including the rules with the corresponding sections and an explanation.

20. The computer program product of claim 19, wherein the program instructions executable by the hardware processor cause the hardware processor to generate the rules before runtime to reduce calls to the large language model.
